(19) United States
(12) Patent Application Publication
(10) Pub. No.: US 2026/0057141 A1
(43) Pub. Date: Feb. 26, 2026

(54) EXTEND STOCHASTIC PETRI NETS-BASED METHOD FOR MODELING AND REPRESENTING PROCESS RELIABILITY OF FLEXIBLE MANUFACTURING SYSTEM

(71) Applicant: Beijing National Innovation Institute of Lightweight Ltd, Beijing (CN)

(72) Inventors: Qian Zhang, Beijing (CN); Wanran Yang, Beijing (CN); Wenzhang Deng, Beijing (CN); Le Wu, Beijing (CN); Bo Zhao, Beijing (CN); Bingji Wang, Beijing (CN); Junchen Pan, Beijing (CN)

(21) Appl. No.: 19/037,035

(22) Filed: Jan. 24, 2025

(30) Foreign Application Priority Data
Aug. 21, 2024 (CN) 202411148350.2

(51) Int. Cl. G06F 30/22; G06F 111/10

(52) U.S. Cl. CPC G06F 30/22; G06F 2111/10

(57) ABSTRACT

Disclosed is an extend stochastic Petri nets (ESPN)-based method for modeling and representing process reliability of a flexible manufacturing system (FMS), falling within the technical field of flexible manufacturing. Modular division is performed on an FMS, and performance parameters of various process modules are acquired; ESPN septuple models corresponding to subnets of Petri nets are constructed according to the performance parameters of the various process modules; based on a process flow, the subnets of Petri nets are combined according to a set control approach; and numerical values of transitions with arbitrary distributions in a complete ESPN model are solved through numerical simulation. In the disclosure, the accuracy for evaluating the process reliability of the FMS is ensured.

### CROSS-REFERENCE TO RELATED APPLICATION

This application claims priority of Chinese Patent Application No. 202411148350.2, filed on Aug. 21, 2024, the entire contents of which are incorporated herein by reference.

### TECHNICAL FIELD

The disclosure relates to the technical field of flexible manufacturing, and more specifically relates to an extend stochastic Petri nets (ESPN)-based method for modeling and representing process reliability of a flexible manufacturing system (FMS).

### BACKGROUND

FMS represents an advanced production system, integrating computer technology, automation technology, and information technology, which can rapidly adjust the layout of production lines and process flows according to changes in production demands, thereby adapting to the production of different products. FMS is an intelligent automated electromechanical manufacturing system formed by a unified information control system, a material storage and transfer system, and several numerical control equipment, capable of adapting to changes in processing objects. FMS is widely applied in manufacturing industries such as automobiles, electronics, aerospace, and medical apparatus.

Since the complex parts and high-end equipment in aerospace are characterized by numerous variety and scalable batch manufacturing, to quickly adapt to the needs of flexible and agile manufacturing, FMS needs to meet the diversity of products and rapid changes in market demands. Conventional production lines are often designed based on fixed process flows, while flexible production lines need to adapt to various production tasks, thereby making further demands on the reliability of flexible production lines. Accordingly, how to accurately represent and evaluate the process reliability of FMS in a multi-task environment has become a major challenge. For a complex FMS, establishing a comprehensive and accurate process reliability model is a complex task, and how to effectively solve the model to provide feasible solutions for evaluating the process reliability of production lines is a technical problem urgently needed to be solved in this field.

Stochastic Petri net (SPN) is a special type of Petri net, which serves as a mathematical representation of discrete parallel systems. In SPN, the times associated with transitions in temporal Petri nets are assumed to be random (following a certain probability distribution). Most SPNs are currently studied under the condition that all random variables representing a finite set of transitions follow the exponential distribution. However, in practice, many variation processes follow normal distribution, Poisson distribution and other distributions, rather than following the exponential distribution. Therefore, the use of SPN based on exponential distribution for modeling and solving has some limitations. For example, Liu Bo et al. proposes a reliability model for a flexible production line for engine cylinder blocks in “Reliability Evaluation of Flexible Production Line for Engine Cylinder Blocks Based on Analytic Hierarchy Process (AHP) Fuzzy Comprehensive Evaluation Method”, using stochastic Petri net package (SPNP) software developed by Professor Kishor S. Trivedi and his team at Duke University, with all types of transitions being assumed to follow the exponential distribution. However, in actual production practice, variables following the normal distribution are more common than those following the exponential distribution, and therefore this modeling method fails to better simulate actual production lines.

ESPN is obtained by further extension of SPN, not only retaining the ability of SPN to mathematically represent discrete parallel systems, but also enhancing its modeling capabilities for time transitions with arbitrary distributions in complex systems. In most of existing representation models for FMS based on ESPN, simulation data is employed for process simulation and simulation calculation. However, modularizing the system process flow of actual flexible manufacturing production lines may encounter problems that real-time data changes during operation. Therefore, how to make models and solution methods adaptable to these changes in real-time to ensure the accuracy of process reliability evaluations for FMS is an urgent problem to be solved.

### SUMMARY

Given that, the disclosure provides an ESPN-based method for modeling and representing process reliability of an FMS, aiming to address the problem that, using the existing methods for modeling and representing process reliability of an FMS, the process reliability of the FMS fails to be accurately evaluated when real-time data changes during system operation.

To realize the above objective, the following solutions are provided:
an ESPN-based method for modeling and representing process reliability of an FMS includes: performing modular division on an FMS based on a production line process flow of the FMS, to obtain various process modules, and acquiring performance parameters of the various process modules;
determining places, transitions, directed arcs, and tokens of subnets of Petri nets corresponding to the various process modules according to the performance parameters of the various process modules, and constructing an ESPN septuple model corresponding to each subnet of Petri net:

$$N = ( P , T , I , O , m , F , L ) ,$$

where P represents a finite set of places, T represents a finite set of transitions, P∪T≠Ø and P∩T≠Ø, I represents an input function, O represents an output function, m represents a mark, representing the distribution of tokens, F represents a firing delay with an arbitrary distribution, and L represents an operation lifetime from an initial state;
combining, based on the sequence of the production line process flow, the subnets of Petri nets corresponding to the various process modules according to a set control approach, to obtain a complete ESPN model of the FMS; and
solving numerical values of transitions with arbitrary distributions in the complete ESPN model through numerical simulation, and analyzing process reliability of the FMS.

Preferably, types of the places in the place set P include: state places and capacity places, the state places being configured to reflect current states of the process modules, and the capacity places being configured to reflect the actual number of parts or capacity of a buffer zone of the FMS;
both the input function I and the output function O represent the number of tokens transferred when the directed arcs are transferred; if a transfer occurs among the state places, a weight of the input function is 1; and if the transfer occurs between the state place and the capacity place, or, among the capacity places, the weight of the input function is an actual process parameter;
in the mark m, an iₜₕ component represents the number of tokens in an iₜₕ place, with an initial mark of m₀, and the number of tokens in the state places is 0 or 1, m=1 indicates that the process module is in that state, and m=0 indicates that the process module is not in that state.

Preferably, a firing rule of the ESPN model is:
in the mark m, when ∀p∈P,t∈T,m(p)≥I(p,t) and H(p,t)≠0,m(p)<H(p,t), the transition is enabled, where H is an inhibitor function used for limiting a capacity upper limit of the place p;
if t∈T is enabled under the mark m, a new mark m′ is generated according to an activation rule, where m′(pi)=m(pᵢ)+O(pᵢ, t)−I(pᵢ, t), t=1, 2, 3, . . . , n.

Preferably, a process of solving numerical values of transitions with arbitrary distributions in the complete ESPN model through numerical simulation includes:
updating the number of tokens in the state places and the capacity places, and updating place matrices according to transition activation status;
determining whether the transitions satisfy an activation condition;
determining whether the transitions have been activated if the activation condition is satisfied;
performing time sampling according to the distribution of the transitions if the transitions have not been activated, and determining a target transition delay;
updating a transition delay matrix according to the target transition delay, and determining a minimum transition delay; and
activating the transitions based on the minimum transition delay according to a preset activation rule, and returning to the step of updating the place matrices according to the transition activation status.

Preferably, after determining whether the current transitions have been activated, the following is further included:
determining an initial transition delay of the transitions as the target transition delay if the transitions have been activated, and executing the steps of updating the transition delay matrix according to the target transition delay and determining the minimum transition delay.

Preferably, an activation rule is:

$$\begin{matrix}{m}^{′} ( {p}_{i} ) = m ( {p}_{i} ) + O ( {p}_{i} , t ) - I ( {p}_{i} , t ) , \\ L = L + {t}^{′} , \\ {t}^{′} = min \{ {t}_{m}^{′} , {t}_{n}^{′} , … , {t}_{l}^{′} \} ,\end{matrix}$$

where t′ represents a minimum transition delay, and L represents an operation lifetime of the model from an initial state.

Preferably, after updating the number of tokens in the state places and in the capacity places, the following is further included:
determining whether the place matrices satisfy a termination condition; and
performing, if the termination condition is not satisfied, the step of determining whether the transitions satisfy the activation condition.

Preferably, after determining whether the place matrices satisfy the termination condition, the following is further included:
outputting simulation results if the termination condition is satisfied;
analyzing the reliability of the various process modules in the FMS based on the simulation results;
adjusting the flexible manufacturing production line based on reliability analysis results;
producing based on an adjusted flexible manufacturing production line, and collecting performance parameters of the various process modules during production; and
updating the performance parameters in the subnets of Petri nets, and performing the step of solving numerical values of transitions with arbitrary distributions in the ESPN model through numerical simulation.

Preferably, the performance parameters include at least one of processing state, buffer quantity, processing time, failure rate, transfer time, and maintenance time.

It can be seen from the above technical solutions, according to the ESPN-based method for modeling and representing process reliability of an FMS provided by the disclosure, modular division is performed on an FMS based on a production line process flow of the FMS, to obtain various process modules, and performance parameters of the various process modules are acquired; places, transitions, directed arcs, and tokens of subnets of Petri nets corresponding to the various process modules are determined according to the performance parameters of the various process modules, and an ESPN septuple model corresponding to each subnet of Petri net is constructed; based on the sequence of the production line process flow, the subnets of Petri nets corresponding to the various process modules are combined according to a set control approach, to obtain a complete ESPN model of the FMS; and finally, numerical values of transitions with arbitrary distributions in the complete ESPN model are solved through numerical simulation, and process reliability of the FMS is analyzed. In the disclosure, a bottom-up approach is employed to establish a modularly combined process reliability representation model based on subnet of Petri net. This model can reflect the interactions between various processes and the impact of task changes on process reliability, thereby better adapting to the dynamic changes of flexible manufacturing production lines. Additionally, a numerical solution method for transitions with arbitrary distributions is employed, so that the process reliability can be reflected rapidly and intuitively when processes vary. Meanwhile, by incorporating actual production process parameters, a reliability representation evaluation based on a combination of actual feedback and simulation data is formed, allowing the model and solution method to adapt to these changes in real-time, thereby ensuring the accuracy of the process reliability evaluation for FMS.

### BRIEF DESCRIPTION OF THE DRAWINGS

To state the technical solutions of the examples in the disclosure or the prior art clearer, the attached drawings needed in the examples or prior art are described briefly below. Obviously, the drawings described below are some examples in the disclosure, and for those ordinary skilled in the art, other drawings can be obtained according to these drawings without creative efforts.

FIG. 1 is a flow chart of an ESPN-based method for modeling and representing process reliability of an FMS provided in an example of the disclosure;

FIG. 2 is a process flow diagram of a flexible manufacturing production line provided in an example of the disclosure;

FIG. 3 is a schematic diagram showing a subnet of a Petri net of a process module provided in an example of the disclosure;

FIG. 4 is a schematic diagram showing an ESPN model of an FMS provided in an example of the disclosure;

FIG. 5 is a flow chart of an ESPN model solution method provided in an example of the disclosure; and

FIG. 6 is a flow chart of an ESPN model solution method with the introduction of actual data feedback provided in an example of the disclosure.

### DETAILED DESCRIPTION

The technical solutions of the examples in the disclosure will be described clearly and completely by reference to the attached drawings of the examples in the disclosure below. Obviously, the examples described are only some, rather than all examples of the disclosure. On the basis of the examples of the disclosure, all other examples obtained by those ordinary skilled in the art without creative efforts fall within the scope of protection of the disclosure.

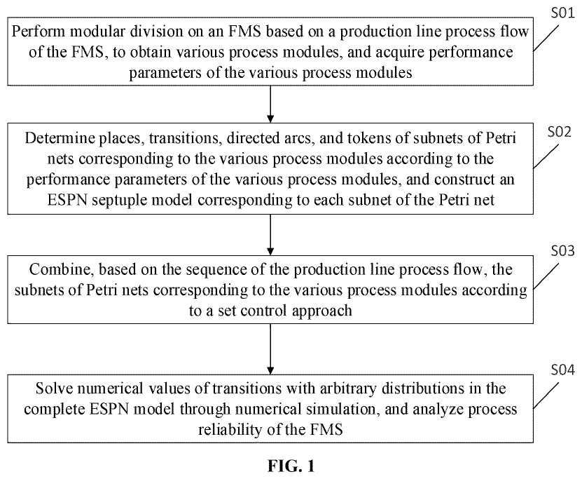

Firstly, referring to FIG. 1, an ESPN-based method for modeling and representing process reliability of an FMS provided in an example of the disclosure is introduced, with the procedure shown as follows.

Step S01, modular division is performed on an FMS based on a production line process flow of the FMS, and performance parameters of the various process modules are acquired.

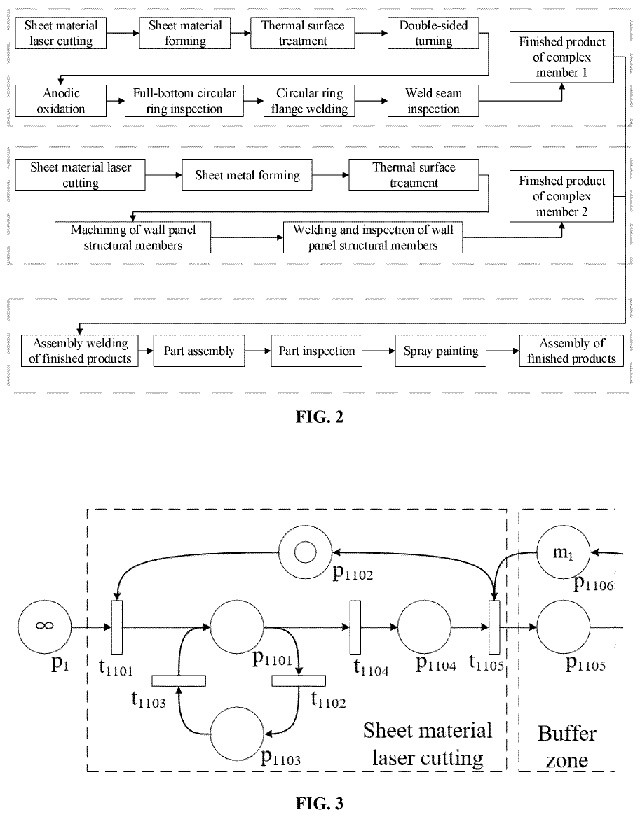

Specifically, the flexible manufacturing production line features reconfigurability, modularity, convertibility, etc, and the composition and process flow of the flexible manufacturing production line can be analyzed. Modular division is performed on the flexible manufacturing production line to obtain various process modules of the process flow. Subsequently, performance parameters of the various process modules during production are collected. The performance parameters include at least one of processing state, buffer quantity, processing time, failure rate, transfer time, maintenance time, and other relevant parameters. As shown in FIG. 2, the process includes: a production process for a complex member 1, a production process for a complex member 2, and an assembly production process for complex members. After modularizing the process flow of each process, the process modules for each process include:
a production process for a complex member 1: sheet material laser cutting, sheet material forming, thermal surface treatment, double-sided turning, inspection, welding, weld seam detection, etc;
a production process for a complex member 2: sheet material laser cutting, sheet metal forming, thermal surface treatment, machining of structural members, welding and detection of structural members, etc; and
an assembly production process for complex members: welding of finished products, assembly of structural members, inspection of structural members, spray painting, etc.

Step S02, places, transitions, directed arcs, and tokens of subnets of Petri nets corresponding to the various process modules are determined according to the performance parameters of the various process modules, and an ESPN septuple model corresponding to each subnet of Petri net is constructed.

Specifically, based on the structure, process flow, resources, and their relationships of a flexible manufacturing production line, a basic framework of an ESPN model is created and described. Firstly, the performance parameters of various process modules in the FMS are classified to determine whether they belong to place or transition. The basic framework of the ESPN model includes places, transitions, directed arcs (connection), and tokens. The directed arcs (connection) serve for connecting places and transitions, representing the flow direction of tokens. Tokens are dynamic objects in places, representing states of things (goods, and machines), information, conditions, or objects. The distribution of tokens determines the state of the Petri net. In the disclosure, marks representing various events (such as start of production, product completion, and fault occurrence) are introduced, which are transferred in the model. Places represent states, and transitions represent changes in states. Performance parameters are primarily associated with time-delayed transitions. Tokens exist within places. A septuple model constructed for each subnet of Petri net is: N=(P, T, I, O, m, F, L).

P represents a finite set of places, P={p₁, p₂, . . . pₙ}, n>0; T represents a finite set of transitions, T={t₁, t₂, . . . , tₛ}, s>0, p∪T≠Ø, and P∩T≠Ø; I: P×T→N is an input function, representing the flow from places to transitions; and O:T×P→N is an output function, representing the flow from transitions to places; N={0, 1, 2, . . . }.

The input function I indicates the number of tokens when the directed arcs are transferred. If a weight of the input function in the state place is 1, it indicates that the state is transferred among the state places. For example, a transfer weight of tokens among p₁₁₀₁, p₁₁₀₂, p₁₁₀₃, and p₁₁₀₄ is 1. When a transfer occurs between a state place and a capacity place, or among capacity places, the input function is the actual number of parts produced in the process. Therefore, when the transfer occurs between p₁₁₀₄ and p₁₁₀₅, the input function is determined according to actual production conditions. If the process produces 10 parts, the weight is 10. This data needs to be determined according to the actually collected data.

The output function O indicates the number of tokens when the directed arcs are transferred. If the weight of the output function when the transfer occurs among state places is 1, it represents a state transfer. If the state is transferred between a state place and a capacity place or among capacity places, the output function represents the actual number of parts produced in the process. This data needs to be determined according to the actually collected data.

m: P→N is a mark, representing the distribution of tokens. The iₜₕ Component indicates the number of tokens in the iₜₕ place, with the initial mark being m₀. The number of tokens in a state place is 0 or 1, indicating the state of the process module. If it is 0, the process module is not in that state. There is only one token in various state places within the same process module. For instance, only one place has a token among p₁₁₀₁, p₁₁₀₂, p₁₁₀₃, and p₁₁₀₄. The number of tokens in capacity places represents quantity, such as the number of tokens in p₁, p₁₁₀₅, and p₁₁₀₆ indicating quantity. This data needs to be determined according to the actually collected data.

F represents a firing delay with an arbitrary distribution, i.e., the time consumed for activating various transitions.

L represents an operation lifetime from an initial state. Recording the runtime of subnet of Petri net serves for analyzing the reliability of the flexible production line from a time-related perspective, such as productivity.

Taking a sheet material laser cutting process module as an example, as shown in FIG. 3, places are represented by circular nodes, representing channels or geographical locations, used for storing tokens. Transitions are represented by square nodes, representing events, transformations, or transmissions, etc, and the occurrence of a transition requires a certain condition. P represents all places. The places include two types: state places and capacity places. State places indicate the process is in a normal, idle, faulty, and completed state. Capacity places represent the capacity and remaining capacity of buffer zones. Depending on the process steps of the production line, the places of the production line need to be adjusted accordingly. In general flexible production lines, there is no requirement for adjustment of places. The performance parameters belonging to places in the sheet material laser cutting process module are shown in Table 1, and the performance parameters belonging to transitions are shown in Table 2.

TABLE 1

| Places | Explanation |
|---|---|
| p₁ | Quantity of blank materials awaiting |
| | processing at the bottom |
| p₁₁₀₁, p₁₁₀₂, p₁₁₀₃, p₁₁₀₄ | Quantity of workpieces in a buffer zone |
| | available for sheet material forming process |
| | when the sheet material laser cutting process |
| | is in a normal, idle, fault, and completed state |
| p₁₁₀₅ | Quantity of workpieces in the buffer zone |
| | available for sheet material forming process |
| p₁₁₀₆ | Remaining capacity of the buffer zone for |
| | accommodating the workpieces after sheet |
| | material laser cutting process |

TABLE 2

| Transitions | Explanation |
|---|---|
| t₁₁₀₁ | Loading workpieces for sheet material laser |
| | cutting process |
| t₁₁₀₂ | Occurrence of fault in sheet material laser |
| | cutting process |
| t₁₁₀₃ | Time required for troubleshooting in sheet |
| | material laser cutting process |
| t₁₁₀₄ | Processing time required for sheet material |
| | laser cutting |
| t₁₁₀₅ | Time required for unloading workpieces and |
| | transporting the same to a storage zone after |
| | sheet material laser cutting |

p₁, p₁₁₀₅, and p₁₁₀₆ are capacity places, and p₁₁₀₁, p₁₁₀₂, p₁₁₀₃, and p₁₁₀₄ are state places. The state places reflect the current status of the process, and the capacity places reflect the actual number of parts or the capacity of the buffer zone in the production line.

In flexible manufacturing production lines, the time required for the same process to produce different parts is different. Therefore, according to the actually collected data, the transition parameters in the model can be modified to ensure the accuracy of the model. The subnet of Petri net for the sheet material laser cutting process module is shown in FIG. 3.

Step S03, based on the sequence of the production line process flow, the subnets of Petri nets corresponding to the various process modules are combined according to a set control approach, to obtain a complete ESPN model of the flexible manufacturing system.

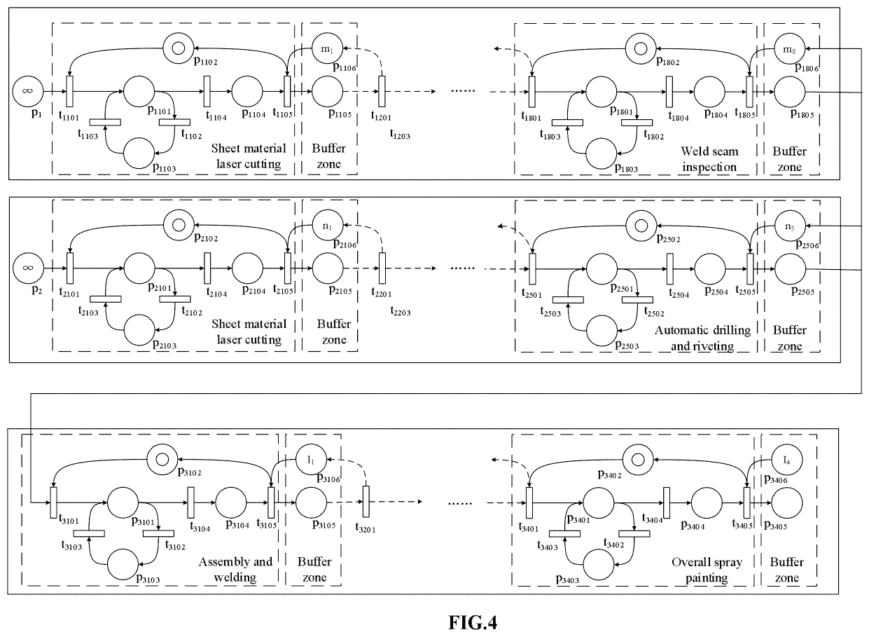

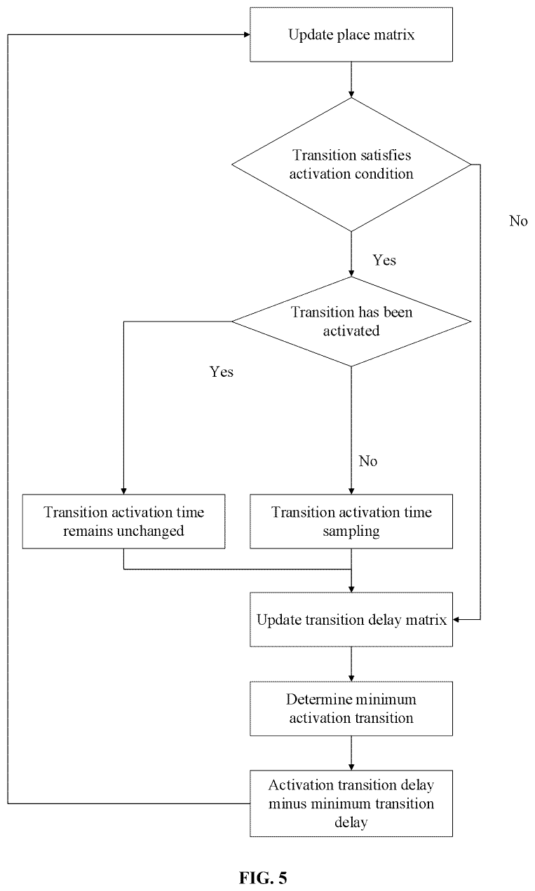

Specifically, according to the actual asynchronous and concurrent condition during processing by the production line, the subnets of Petri nets of different process modules are combined according to a certain control approach, ultimately establishing a complete ESPN model for the entire system. The subnets of Petri nets of different process modules can be combined according to the process flow, to obtain a complete ESPN model for the FMS. For example, following the process flow shown in FIG. 2, the subnets of Petri nets of various process modules are combined to obtain the complete ESPN model as shown in FIG. 4. This flexible manufacturing production line includes two manufacturing production lines and one assembly and inspection line. The first two images in FIG. 4 are manufacturing production lines and the last image is the assembly and inspection line. By analyzing the distribution of transition times between various links, probability distribution models for various transitions are determined.

The prerequisite for a transition to be fire (i.e., to be enabled) is that the number of tokens in all its input places is at least equal to the sum of the weights of the directed arcs from those places to the transition. If all the input places satisfy this condition, this transition is enabled. A firing rule of the ESPN model is as follows.

1) In the mark m, when ∀p∈P, t∈T,m(p)≥I(p, t) and H(p, t)≠0,m(p)<H(p, t), the transition t∈T is enabled, where H represents an inhibitor function used for limiting a capacity upper limit of the place p.

2) If t∈T is enabled under the mark m, a new mark m′ is generated according to an activation rule, m′(pᵢ)=m(pᵢ)+O(pᵢ,t)−I(pᵢ, t), t=1, 2, 3, . . . n.

A prominent feature of ESPN is that it allows for arbitrarily distributed time transitions. If all time transitions follow an exponential distribution, the ESPN can be converted into a Markov chain. If the time transitions follow an exponential distributions and an instantaneous transition, the ESPN can be converted into a generalized SNP, and can ultimately be converted into a Markov chain. If the time transitions follow a deterministic time distribution, the ESPN can be converted into a discrete-time Markov chain.

Step S04, numerical values of transitions with arbitrary distributions in the complete ESPN model are solved through numerical simulation, and process reliability of the FMS is analyzed.

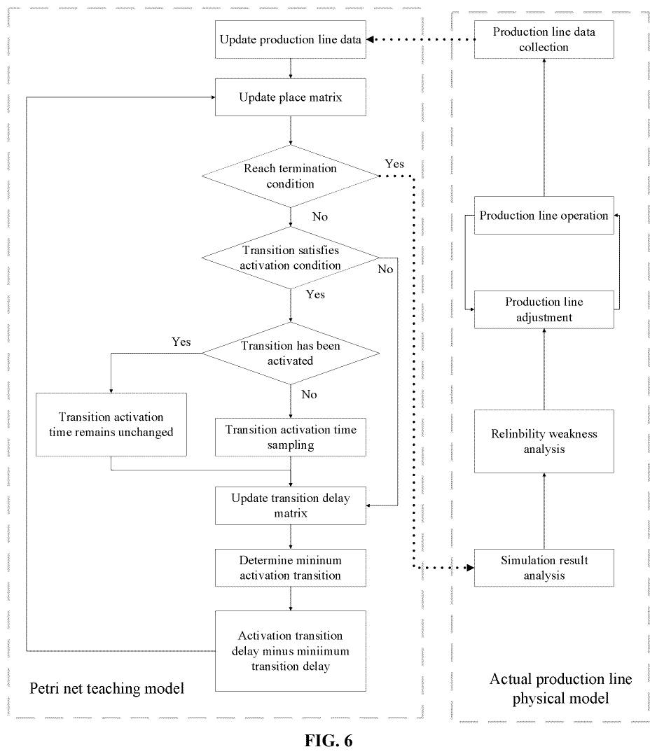

Specifically, as shown in FIG. 5, place matrices are updated: the number of tokens in the state places and in the capacity places is updated, and the place matrices are updated according to transition activation status.

Transitions {tₘ, tₙ, . . . , t₁} satisfying an activation condition are selected. Whether the transitions satisfy the activation condition is determined; if not, the step of updating a transition delay matrix is performed; and if so, whether the transitions have been activated is determined.

If the transitions have not been activated, time sampling is performed according to the distribution of transitions, to determine a target transition delay. If the transitions have been activated, an initial transition delay of the transitions is set as the target transition delay. By determining which transitions are in the activated state and which are not, the delay of transitions that are already activated remains unchanged, while the specific delay value for unactivated transitions will be determined through sampling based on the distribution.

A transition delay matrix is updated, and the activation time of the activated transitions is determined, and the minimum value in the delay matrix is determined to make the completion of activation. According to the target transition delay, the transition delay matrix is updated, and the minimum transition delay is determined. Based on the minimum transition delay, the transitions are activated according to the preset activation rule, and the step of updating the place matrices according to the transition activation status is performed. The activation rule is as follows:

$$\begin{matrix}{m}^{′} ( {p}_{i} ) = m ( {p}_{i} ) + O ( {p}_{i} , t ) - I ( {p}_{i} , t ) , \\ L = L + {t}^{′} , \\ {t}^{′} = min \{ {t}_{m}^{′} , {t}_{n}^{′} , … , {t}_{l}^{′} \} ,\end{matrix}$$

where t′ represents the minimum delay transition, and L represents an operation lifetime of the model from an initial state.

Through numerical simulation, the numerical values of transitions with arbitrary distributions in the ESPN model are solved to obtain system indicators of the FMS. The system indicators include at least one of the average processing time of the entire production line under undamaged conditions, the reliability and the productivity of the flexible manufacturing production line in a certain state.

According to the ESPN-based method for modeling and representing process reliability of an FMS provided by the disclosure, modular division is performed on an FMS based on a production line process flow of the FMS, to obtain various process modules, and performance parameters of the various process modules are acquired; places, transitions, directed arcs, and tokens of subnets of Petri nets corresponding to the various process modules are determined according to the performance parameters of the various process modules, and an ESPN septuple model corresponding to each subnet of Petri net is constructed; based on the sequence of the production line process flow, the subnets of Petri nets corresponding to the various process modules are combined according to a set control approach, to obtain a complete ESPN model of the FMS; and finally, numerical values of transitions with arbitrary distributions in the complete ESPN model are solved through numerical simulation, and process reliability of the FMS is analyzed. In the disclosure, a bottom-up approach is employed to establish a modularly combined process reliability representation model based on subnet of Petri net. This model can reflect the interactions between various processes and the impact of task changes on process reliability, thereby better adapting to the dynamic changes of flexible manufacturing production lines. Additionally, a numerical solution method for transitions with arbitrary distributions is employed, so that the process reliability can be rapidly and intuitively reflected when processes vary. Meanwhile, by incorporating actual production process parameters, a reliability representation evaluation based on a combination of actual feedback and simulation data is formed, allowing the model and solution method to adapt to these changes in real-time, thereby ensuring the accuracy of the process reliability evaluation for FMS.

As shown in FIG. 6, in an example of the disclosure, based on the process of solving the numerical values of transitions with arbitrary distributions in the ESPN model through numerical simulation in the aforementioned example, after updating the number of token in the state places and in the capacity places, the following is further included.

It is determined whether the place matrices satisfy a termination condition. If not, the step of determining whether the transitions satisfy the activation condition is performed; and if so, the simulation results are outputted. The termination condition is the set maximum number of simulations.

The reliability of the various process modules in the FMS is analyzed based on the simulation results, and the reliability weakness is determined, which is analyzed to obtain reliability analysis results.

The flexible manufacturing production line is adjusted based on the reliability analysis results.

Producing is performed based on the adjusted flexible manufacturing production line, and performance parameters of the various process modules during production are collected.

The performance parameters in the subnets of Petri nets are updated, and the step of solving numerical values of transitions with arbitrary distributions in the ESPN model through numerical simulation is performed.

An ESPN-based device for modeling and representing process reliability of an FMS provided in an example of the disclosure is described below. The device described below can be cross-referenced with the ESPN-based method for modeling and representing process reliability of an FMS described above.

An ESPN-based device for modeling and representing process reliability of an FMS is introduced, and the device includes:
a flow division unit, configured to perform modular division on an FMS based on a production line process flow of the FMS, to obtain various process modules, and acquire performance parameters of the various process modules;
a model construction unit, configured to determine places, transitions, directed arcs, and tokens of subnets of Petri nets corresponding to the various process modules according to the performance parameters of the various process modules, and construct an ESPN septuple model corresponding to the subnet of each Petri net:

$$N = ( P , T , I , O , m , F , L )$$

where P represents a finite set of places, T represents a finite set of transitions, P∪T≠Ø and P∩T≠Ø, I represents an input function, O represents an output function, m represents a mark, representing the distribution of tokens, F represents a firing delay with an arbitrary distribution, and L represents an operation lifetime from an initial state;

a model combination unit, configured to combine, based on the sequence of the production line process flow, the subnets of Petri nets corresponding to the various process modules according to a set control approach, to obtain a complete ESPN model of the FMS; and

a numerical value simulation unit, configured to solve numerical values of transitions with arbitrary distributions in the complete ESPN model through numerical simulation, and analyze process reliability of the FMS.

An example of the disclosure further provides a storage medium, which can store programs suitable for execution by a processor. The programs are employed to implement the various processing flows in the ESPN-based solutions for modeling and representing process reliability of an FMS described above.

Finally, it is to be noted that, herein, the relation terms such as first and second are merely used for distinguishing one entity or operation from another entity or operation, rather than necessarily demanding or implying the existence of any such actual relationship or order between these entities or operations.

The various examples in the specification are described in a progressive approach, with each example focusing on the differences from other examples. The same or similar parts among the various examples can be referred to each other.

The foregoing description of the disclosed examples enables a person skilled in the art to realize or use the disclosure. Various modifications to these examples will be apparent to those skilled in the art, and the general principles defined herein may be realized in other examples without departing from the spirit or scope of the disclosure. Accordingly, the disclosure will not be limited to these examples shown herein, but will be subjected to the broadest scope consistent with the principles and novel features disclosed herein.

1. An extend stochastic Petri nets (ESPN)-based method for modeling and representing process reliability of a flexible manufacturing system (FMS), comprising:
performing modular division on an FMS based on a production line process flow of the FMS, to obtain various process modules, and acquiring performance parameters of the various process modules,
determining places, transitions, directed arcs, and tokens of subnets of Petri nets corresponding to the various process modules according to the performance parameters of the various process modules, and constructing an ESPN septuple model corresponding to each subnet of the Petri net:
$$N = ( P , T , I , O , m , F , L ) ,$$
where P represents a finite set of the places, T represents a finite set of the transitions, P∪T≠Ø and P∩T≠Ø, I represents an input function, O represents an output function, m represents a mark representing the distribution of tokens, F represents a firing delay with adistribution, and L represents an operation lifetime from an initial state, wherein
types of the places in the place set P comprise: state places and capacity places, the state places being configured to reflect current states of the various process modules, and the capacity places being configured to reflect an actual number of parts or capacity of a buffer zone of the FMS;
both the input function I and the output function O represent a number of the tokens transferred under a condition that the directed arcs are transferred, wherein if a transfer occurs among the state places, a weight of the input function is 1, indicating a state transfer, and if the transfer occurs between the state place and the capacity place, or, among the capacity places, the input function is an actual process parameter;
in the mark m, an iₜₕ component represents the number of the tokens in an iₜₕ place, with an initial mark of m₀, and the number of the tokens in the state places is 0 or 1, m=1 indicates that the process module is in that state, and m=0 indicates that the process module is not in that state;
combining, based on a sequence of the production line process flow, the subnets of the Petri nets corresponding to the various process modules according to a set control approach, to obtain a complete ESPN model of the FMS,
solving numerical values of the transitions with distributions in the complete ESPN model through numerical simulation, and analyzing process reliability of the FMS to obtain reliability analysis results,
adjusting a layout of a flexible manufacturing production line of the FMS and the production line process flow based on reliability analysis results,
wherein a firing rule of the ESPN model is as follows:
in the mark m, when ∀p∈P, t∈T, m(p)≥I(p, t) and H(p, t)≠0,m(p)<H(p, t), a transition t∈T is enabled, where H is an inhibitor function used for limiting a capacity upper limit of the place p;
if t∈T is enabled under the mark m, a new mark m′ is generated according to an activation rule, where m′(pᵢ)=m(pᵢ)+O(pᵢ, t)−I(pᵢ, t), t=1, 2, 3, . . . , n, the activation rule being:
$$\begin{matrix}{m}^{′} ( {p}_{i} ) = m ( {p}_{i} ) + O ( {p}_{i} , t ) - I ( {p}_{i} , t ) , \\ L = L + {t}^{′} , \\ {t}^{′} = min \{ {t}_{m}^{′} , {t}_{n}^{′} , … , {t}_{l}^{′} \} ,\end{matrix}$$
where t′ represents a minimum transition delay, n is a positive integer number, l is a positive integer number, and L represents an operation lifetime of the model from an initial state;
wherein the solving numerical values of the transitions with distributions in the complete ESPN model through numerical simulation comprises:
updating the number of the tokens in the state places and in the capacity places, and
updating place matrices according to transition activation status;
determining whether the transitions satisfy activation conditions;
determining whether the transitions have been activated if the activation conditions are satisfied;
performing time sampling according to the distribution of the transitions if the transitions have not been activated, and determining a target transition delay;
updating a transition delay matrix according to the target transition delay, and determining a minimum transition delay; and
activating the transitions based on the minimum transition delay according to a preset activation rule, and returning to and executing the step of updating the place matrices according to the transition activation status;
wherein the ESPN-based method for modeling and representing process reliability of an FMS further comprises:
adjusting a flexible manufacturing production line of different products based on the reliability analysis results to obtain an adjusted flexible manufacturing production line; and
performing producing based on the adjusted flexible manufacturing production line to obtain the different products, wherein the producing comprises: sheet material laser cutting, sheet material forming, thermal surface treatment, double-sided turning, anodic oxidation, inspection, welding, weld seam detection, and spray painting.

2. The ESPN-based method for modeling and representing process reliability of an FMS according to claim 1, wherein after determining whether current transitions have been activated, the following is further comprised:
determining an initial transition delay of the transitions as the target transition delay if the transitions have been activated, and executing the steps of updating the transition delay matrix according to the target transition delay and determining the minimum transition delay.

3. The ESPN-based method for modeling and representing process reliability of an FMS according to claim 1, wherein after updating the number of tokens in the state places and in the capacity places, the following is further comprised:
determining whether the place matrices satisfy a termination condition; and
performing, if the termination condition is not satisfied, the step of determining whether the transitions satisfy the activation condition.

4. The ESPN-based method for modeling and representing process reliability of an FMS according to claim 3, wherein after determining whether the place matrices satisfy the termination condition, the following is further comprised:
outputting simulation results if the termination condition is satisfied;
analyzing the reliability of the various process modules in the FMS based on the simulation results;
producing based on an adjusted flexible manufacturing production line, and collecting performance parameters of the various process modules during production; and
updating performance parameters in the subnets of the Petri nets, and performing the step of solving numerical values of the transitions with distributions in the ESPN model through numerical simulation.

5. The ESPN-based method for modeling and representing process reliability of an FMS according to claim 1, wherein the performance parameters comprise at least one of processing state, buffer quantity, processing time, failure rate, transfer time, and maintenance time.

6. The ESPN-based method for modeling and representing process reliability of an FMS according to claim 2, wherein the performance parameters comprise at least one of processing state, buffer quantity, processing time, failure rate, transfer time, and maintenance time.

7. The ESPN-based method for modeling and representing process reliability of an FMS according to claim 3, wherein the performance parameters comprise at least one of processing state, buffer quantity, processing time, failure rate, transfer time, and maintenance time.

8. The ESPN-based method for modeling and representing process reliability of an FMS according to claim 4, wherein the performance parameters comprise at least one of processing state, buffer quantity, processing time, failure rate, transfer time, and maintenance time.
